(19) United States
(12) Patent Application Publication
(10) Pub. No.: US 2025/0226151 A1
(43) Pub. Date: Jul. 10, 2025

(54) INJECTION MOLDING TOOLING

(71) Applicant: Delta Electronics (Shanghai) Co., Ltd., Shanghai (CN)

(72) Inventors: Pengkai JI, Shanghai (CN); Shouyu HONG, Shanghai (CN); Jinping ZHOU, Shanghai (CN); Min ZHOU, Shanghai (CN); Jianhong ZENG, Shanghai (CN); Zhenqing ZHAO, Shanghai (CN)

(21) Appl. No.: 19/088,970

(22) Filed: Mar. 24, 2025

Related U.S. Application Data
(62) Division of application No. 16/735,657, filed on Jan. 6, 2020, now Pat. No. 12,288,642.

(30) Foreign Application Priority Data
Jan. 7, 2019 (CN) 201910013476.1

(51) Int. Cl. H01F 41/02; H01F 1/24; H01F 27/26; H01F 41/04

(52) U.S. Cl. CPC H01F 41/0246; H01F 1/24; H01F 27/266; H01F 41/04

(57) ABSTRACT

Disclosed is an injection molding tooling of an inductor with a vertical winding, including: an upper punch, a molding cavity body and a lower punch, the lower punch being configured to bear a connection piece of a conductive member, the molding cavity body being disposed around a periphery of a pillar of the conductive member, and the upper punch being configured to stamp a magnetic material, such that the magnetic material and the conductive member form an integrated structure.

### CROSS-REFERENCE TO RELATED APPLICATION

This application is a divisional application of U.S. patent application Ser. No. 16/735,657, filed on Jan. 6, 2020, which claims priority to Chinese Patent Application No. 201910013476.1, filed on Jan. 7, 2019, which is hereby incorporated by reference in its entirety.

### TECHNICAL FIELD

The disclosure relates to a fabrication method of an inductor with a vertical winding and an injection molding tooling thereof, and belongs to the technical field of power electronics.

### BACKGROUND

As a basic electronic component, the inductor is widely used in the power circuit. Existing inductors mainly include the inductor with a horizontal winding and the inductor with a vertical winding. The inductor with the vertical winding is beneficial to vertical heat dissipation, especially when such an inductor is stacked with the chip to form a power module, and additionally beneficial to upward heat transfer and dissipation comparing with the inductor with the horizontal winding.

Nowadays, high frequency power modules with the inductor are widely required in more applications, thus it is necessary to reduce the volume of the inductor and increase its saturation current in response to the demand of smaller high frequency power modules. Therefore, the search for how to produce an inductor suitable for high-frequency power module is becoming increasingly urgent. However, in the prior art, the winding of the inductor needs to be clamped and positioned first before producing the inductor by means of magnetic material injection. This method is relatively easy to be realized for the horizontal winding, but it is difficult for the vertical winding to be clamped and positioned by a clamp. In addition, for a coupled inductor, in which multiple vertical windings are arranged side by side, it is difficult laying the vertical windings flat for the injection because the vertical winding is susceptible to deformation or displacement during the magnetic material injection, seriously degrading the inductor quality.

### SUMMARY

The present disclosure provides a fabrication method of an inductor with a vertical winding and an injecting molding tooling thereof, so as to address the above or other potential problems of the prior art.

An aspect of the present disclosure provides a fabrication method of an inductor with a vertical winding, including: providing a conductive member that includes a connection piece and a pillar, the connection piece including a first surface and a second surface that are oppositely arranged, and the pillar being disposed on the first surface; injecting a magnetic material onto the conductive member, such that the magnetic material and the conductive member form an integrated structure; and cutting the connection piece to form the vertical winding.

Another aspect of the present disclosure provides an injection molding tooling of an inductor with a vertical winding, including: an upper punch, a molding cavity body and a lower punch, the lower punch being configured to bear a connection piece of a conductive member, the molding cavity body being disposed around a periphery of a pillar of the conductive member, and the upper punch being configured to stamp a magnetic material, such that the magnetic material and the conductive member form an integrated structure.

According to the solution of the embodiment of the present disclosure, an inductor with a vertical winding can be fabricated, and the possibility of deformation in, or displacement of, the vertical winding can be reduced.

Some advantages of additional aspects of the disclosure will be set forth in the description below, some will become apparent from the description below, or will be appreciated through the practice of the disclosure.

### BRIEF DESCRIPTION OF THE DRAWINGS

The above and other objectives, features and advantages of the embodiments of the present disclosure will be more easily understood by reference to the following detailed description of the appended drawings. In the appended drawings, multiple embodiments of the disclosure will be illustrated by way of example in a non-limiting manner, where:

FIG. 1a to FIG. 1h are schematic diagrams illustrating a fabrication method provided in Embodiment 1 of the present disclosure;

FIG. 2 is a schematic structural diagram of an inductor fabricated according to the fabrication method of FIG. 1a to FIG. 1h;

FIG. 3a to FIG. 3c are schematic diagrams illustrating a fabrication method provided in Embodiment 2 of the present disclosure;

FIG. 4 is a schematic structural diagram of an inductor fabricated according to the fabrication method of FIG. 3a to FIG. 3c;

FIG. 5a to FIG. 5d are schematic diagrams illustrating a fabrication method provided in Embodiment 3 of the present disclosure;

FIG. 6 is a schematic structural diagram of an inductor fabricated according to the fabrication method of FIG. 5a to FIG. 5d;

FIG. 7a to FIG. 7d are schematic diagrams illustrating a fabrication method provided in Embodiment 4 of the present disclosure;

FIG. 8 is a schematic structural diagram of an inductor fabricated according to the fabrication method of FIG. 7a to FIG. 7d;

FIG. 9 is a schematic diagram illustrating a fabrication method provided in Embodiment 5 of the present disclosure, where an end part of the vertical winding is exposed after injection;

FIG. 10a to FIG. 10d are schematic diagrams illustrating a fabrication method provided in Embodiment 6 of the present disclosure, where different magnetically permeable materials are disposed between vertical windings;

FIG. 11a to FIG. 11i are schematic diagrams illustrating a fabrication method provided in Embodiment 7 of the present disclosure, where different magnetically permeable materials are disposed between vertical windings;

FIG. 12 is a schematic diagram illustrating a fabrication method provided in Embodiment 8 of the present disclosure;

FIG. 13a to FIG. 13c are schematic diagrams illustrating a fabrication method provided in Embodiment 9 of the present disclosure;

FIG. 14a and FIG. 14b are schematic diagrams illustrating a fabrication method provided in Embodiment 10 of the present disclosure;

FIG. 15 is a schematic diagram illustrating a fabrication method provided in Embodiment 11 of the present disclosure;

FIG. 16a and FIG. 16b are schematic diagrams illustrating a fabrication method provided in Embodiment 12 of the present disclosure, where surfaces of a connection piece and a vertical winding are coated or attached with a composite material;

FIG. 17a to FIG. 17c are schematic diagrams illustrating three-dimensionally crossed windings connected through a metallization method as provided in Embodiment 13 of the present disclosure;

FIG. 18a to FIG. 18c are schematic diagrams illustrating double-side crossed windings connected through a metallization method as provided in Embodiment 13 of the present disclosure;

FIG. 19a to FIG. 19f are schematic diagrams illustrating a fabrication method provided in Embodiment 15 of the present disclosure, where the conductive member is formed by stamping a sheet metal;

FIG. 20a to FIG. 20f are schematic diagrams illustrating a fabrication method provided in Embodiment 16 of the present disclosure, where the conductive member is formed by stamping a sheet metal; and

FIG. 21a to FIG. 21f are schematic diagrams illustrating a fabrication method provided in Embodiment 17 of the present disclosure, where the conductive member is formed by stamping a sheet metal.

### DESCRIPTION OF EMBODIMENTS

Embodiments of the present disclosure are described in detail below, and examples of the embodiments are illustrated in the appended drawings, where like elements or elements having like functions are identified by like reference numerals throughout the appended drawings. The embodiments described below with reference to the appended drawings are exemplary, and are intended to be illustrative, and not to be construed as a limitation, of the disclosure.

It should be understood that the following embodiments do not limit the sequence of steps in the method protected by the present disclosure. Each step of the method of the present disclosure can be performed in any possible order and in a cyclical manner as long as no contradiction arises.

### Embodiment 1

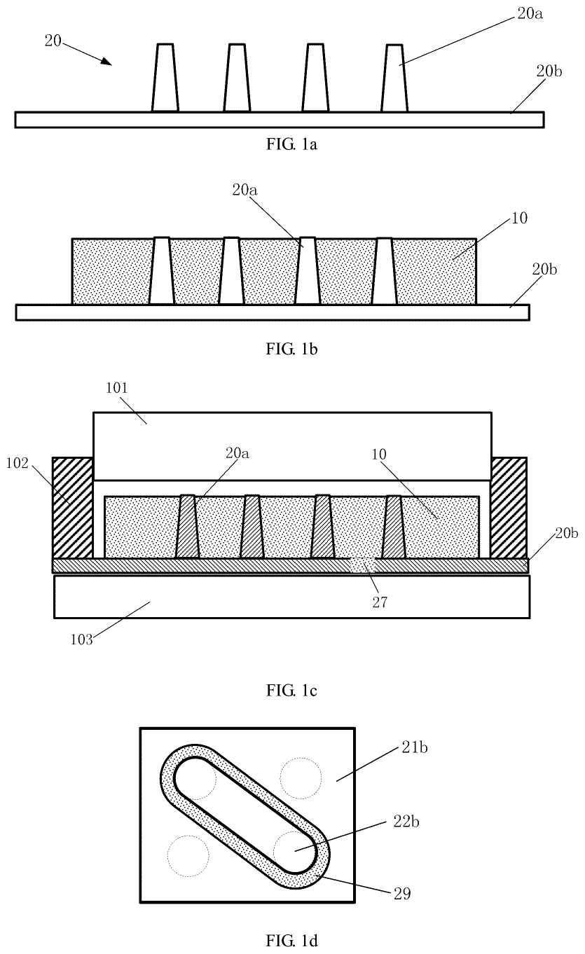

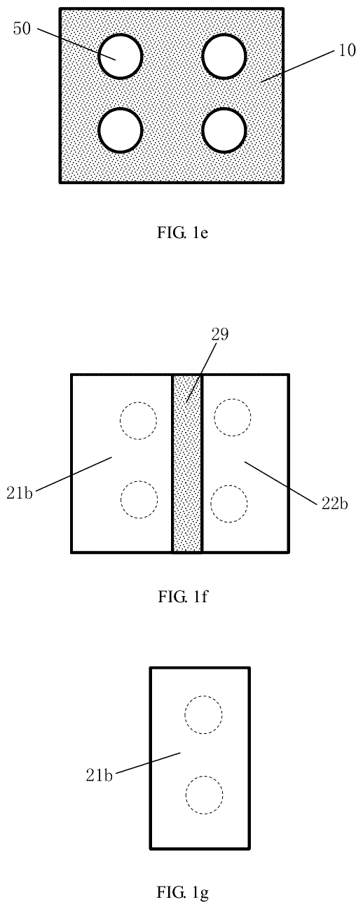

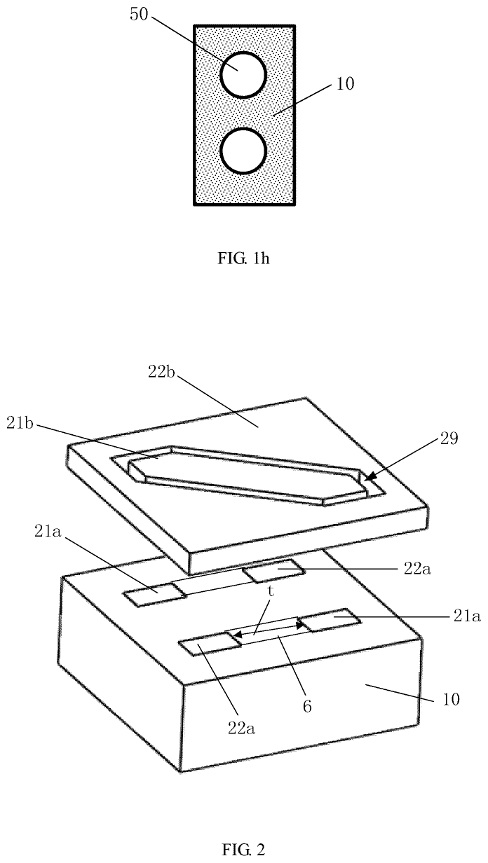

FIG. 1a to FIG. 1c are schematic diagrams illustrating a process of a fabrication method of an inductor having a vertical winding according to the present embodiment, and FIG. 2 is a schematic structural diagram of an inductor fabricated according to the fabrication method of FIG. 1a to FIG. 1c.

Firstly, as shown in FIG. 1a, there is provided a conductive member 20 which includes a connection piece 20b and a plurality of conductive pillars 20a disposed on the surface of the connection piece 20b. The pillar 20a can be perpendicular to the connection piece 20b, and can be produced in various ways, such as etching on a copper sheet, or electroplating, stamping, engraving, or welding onto the connection piece 20b.

Still referring to FIG. 1a, the plurality of pillars 20a are spaced apart on the upper surface of the connection piece. For example, they may be linearly arranged, e.g., be arranged in a row. Alternatively, they may be arranged as a matrix pattern, e.g., in a plurality of rows and pillars, such as two rows and two pillars as shown in FIG. 1d or FIG. 1e. Preferably, the conductive member 20 that arranges pillars 20a into a matrix form is particularly beneficial to formation of multi-phase coupled magnetic elements. In other words, the conductive member 20 that arranges pillars 20a into a matrix form is more beneficial to the panel type production method and to production efficiency improvement. However, the process of the present disclosure has an enhanced applicability to formation of magnetic elements through injection on a conductive member 20 on which pillars 20a are arranged in a matrix form. The profile (i.e., the longitudinal section) of the pillar 20a may be a trapezoid as shown in FIG. 1a, or may be a rectangle. The pillar 20a having a trapezoidal profile is more beneficial to flowing of the magnetic material during the injection process, reducing the force applied onto the pillar 20a during the injection process. The pillar 20a having a rectangular profile has more uniform resistance along the direction of the current flow while serving as the winding of the magnetic element, thereby facilitating improvement of the utilization rate of materials used for producing the conductive member 20. The cross section of the pillar 20a may be a circle, as shown in FIG. 1e, or it may also be a rectangle, as shown in FIG. 2. Certainly, shapes of both the longitudinal section and the cross section of the pillar 20a are not limited to the above shapes. Rather, they can be flexibly set to any suitable shape according to the formation process of the pillar 20a.

Then, as shown in FIG. 1b, a magnetic material 10 is injected onto the conductive member 20 shown in FIG. 1a by using a molding tooling. Specifically, the magnetic material 10 is injected from the top (i.e., the pillar side) of the conductive member 20 onto the conductive member 20. When the magnetic material 10 is injected onto the conductive member 20, since the pillar 20a of the conductive member 20 and the connection piece 20b are integrated, the structure of the conductive member 20 can remain essentially stable throughout the injection process. For example, when a magnetic material of a powder core type, such as magnetic powder, is used for injection, the impact force onto the pillar 20a during the injection process can be fairly absorbed by the connection piece 20b, and the impact force from the magnetic powder to the pillar 20a can become more manageable. In some examples, when the height of the pillar 20a is relatively small, and the section of the pillar 20a is a cylinder, particularly, a tapered cylinder, the degree of displacement and deformation between pillars 20a becomes much smaller, thereby being beneficial to improvement of accuracy of characteristics for the magnetic element, such as accuracy of the inductance, or accuracy of leakage inductance.

FIG. 1c illustrates a structure of an injection molding tooling on the basis of FIG. 1b. As shown in FIG. 1c, the injection molding tooling includes: an upper punch 101, a molding cavity body 102 and a lower punch 103. During the injection, the connection piece of the conductive member 20 is firstly placed on the lower punch 103, and the molding cavity body 102 is then placed, so that the molding cavity body 102, the conductive member 20 and the lower punch 103 enclose an injection molding cavity. After the magnetic material 10 is filled into the injection molding cavity, the magnetic material 10 and the conductive member 20 are integrated through pressing by the upper punch 101. Certainly, during the injection process, the injection molding tooling or the magnetic material can also be heated to ensure that injection molding is performed on the magnetic element at a suitable temperature, to improve its density and performance. Certainly, it is also possible to provide a through hole 27 on the connection piece 20b, as shown in FIG. 1c. In some examples, the magnetic material 10 may be accommodated within the through hole 27, as shown in FIG. 1c, to reinforce the connection between the magnetic material 10 and the conductive member 20. In other examples, the through hole 27 may also be used as part of the magnetic circuit.

As shown in FIG. 1d (which corresponds to the bottom view of FIG. 1b), an annular separation groove 29 is cut into the connection piece 20b by etching, engraving or other suitable means to divide the connection piece 20b into two parts, i.e., 21b and 22b. As a result, a portion of the winding is crossed outside the magnetic channel. Taking FIG. 1d as an example, the winding is crossed at the lower end of the magnetic channel to form an inductor with crossed windings. Specifically, FIG. 1d shows a method of cutting the area on the connection piece corresponding to four adjacent pillars to form crossed vertical windings. Obviously, the four adjacent pillars shown in FIG. 1d are arranged in a matrix of two rows and two pillars.

It should be understood that, although FIG. 1d divides the connection piece 20b into two larger parts by the separation groove 29, in other examples, a vertical separation groove 29 (of course, a horizontal separation groove 29 is also possible) can be cut into the connection piece, as shown in FIG. 1f, so that the connection piece is divided into two parts, i.e., 21b and 22b, so as to form a coupled inductor with non-crossed windings. Obviously, the four adjacent pillars shown in FIG. 1f are also arranged in two rows and two pillars.

Moreover, in other examples, the connection piece 20b can be further cut into even smaller parts, as will be described below.

The bottom of the inductor shown in FIG. 1f is the same as that shown in FIG. 1d, and both are the same as shown in FIG. 1e (which corresponds to the top view of FIG. 1b). A plurality of pads 50 are formed at the other end of the magnetic channel. Taking FIG. 1b as an example, the pad 50 is formed at the upper end of the magnetic channel.

It should be noted here that, according to the needs of the production process, in some examples, the inductor produced according to the above method may be further cut, for example, a molding part of a panel may be cut into individual magnetic elements, or the connection piece 20b may be cut. For example, FIG. 1g and FIG. 1h illustrate that FIG. 1b is cut into a single-phase inductor, where FIG. 1g is the top view, FIG. 1h is the bottom view, and 50 indicates a pad. In other examples, insulation is applied to the cut surface (such as a magnetic surface), or the conductive portion partially covered by a magnetic is de-burred, or deflashing is applied to the overflow magnetic material covering the winding, that is, part of the magnetic material is removed to expose the conductive portion, such as the pad 50. Alternatively, the surface of the magnetic element is coated with a highly magnetically permeable material to facilitate magnetic field shielding.

Further, in some examples, the magnetic material may be injected, or the permeability material may be filled, into the separation groove 29. That is, the magnetic material is secondarily injected, or the permeability material is filled, from the pillar-free side to the conductive member 20, so as to increase the number of magnetic channels.

FIG. 2 illustrates an inductor with crossed windings produced according to the method for producing an inductor shown in FIG. 1. As shown in FIG. 2, two vertical windings 21a and one horizontal winding 21b form a first winding, two vertical windings 22a and one horizontal winding 22b form a second winding, and the first winding and the second winding cross on the same horizontal plane, and the crossed portion thereof are the horizontal windings 21b and 22b. The vertical windings 21a and 22a may be squares, disks, or other shapes. Certainly, the magnetic material 10 is also injected to the outside of the first winding and the second winding. See FIG. 1d and FIG. 1e for the top view and the bottom view of FIG. 2.

Furthermore, FIG. 2 also shows a gap 6 and a spacing t between vertical windings 21a and 22a. In some examples, magnetic materials having different relative magnetic permeability may be added into the gap 6 between the vertical windings 21a and 22a to adjust the coupling coefficient. In other examples, the coupling coefficient can also be adjusted by, for example, adjusting the spacing t between the vertical windings 21a and 22a.

### Embodiment 2

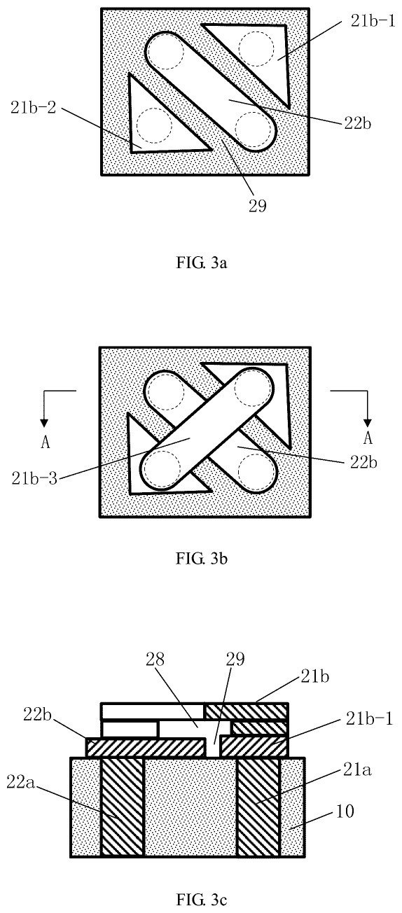

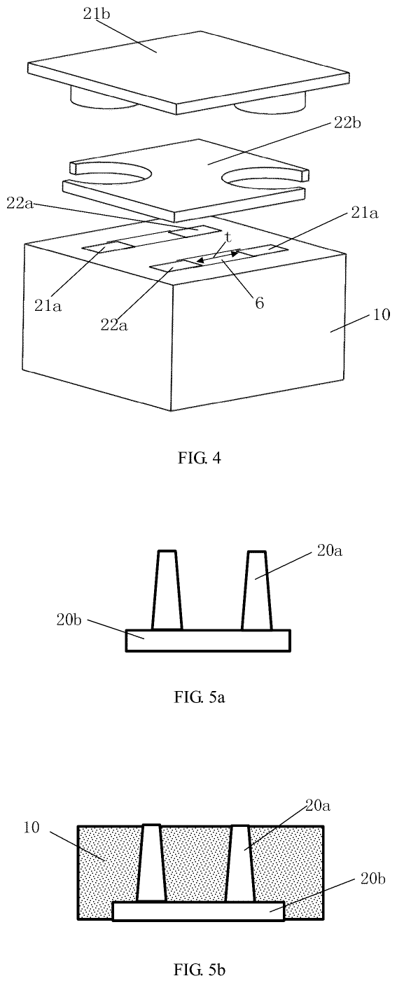

The difference between the present embodiment and Embodiment 1 is that the shape of the separation groove 29 formed on the connection piece is different. As shown in FIG. 3a, the present embodiment expands the separation groove 29 on the basis of FIG. 1d, so that the connection piece 21b is divided into two separate parts, i.e., 21b-1 and 21b-2. Then, as shown in FIG. 3b, the connection piece 21b-3 is welded to the connection pieces 21b-1 and 21b-2 to join the two, and is insulated from 22b, so as to form a three-dimensional crossed anti-coupled inductor. FIG. 3c illustrates a cross-sectional view of the inductor shown in FIG. 3b, and FIG. 4 illustrates an exploded view of the inductor shown in FIG. 3b. As shown in FIG. 4, there is a gap 6 between the vertical windings 21a and 22a, with the spacing of the gap 6 being t, and the gap 6 and the spacing t will be used below for adjusting the coupling coefficient.

### Embodiment 3

The difference between the present embodiment and Embodiment 1 is that the magnetic material 10 surrounds the entire conductive member 20. As shown in FIG. 5a, the conductive member 20 includes the connection piece 20b and the conductive pillar 20a. Refer to above embodiments for the fabrication method of the conductive member 20, which will not be repeated herein.

As shown in FIG. 5b to FIG. 5d, the magnetic material 10 is injected from the top of the conductive member 20 onto the conductive member 20, so that the magnetic material 10 is integrated with the connection piece 20b and the pillar 20a. In the present embodiment, the connection piece 20b is wrapped around by the magnetic material 10. Thus, the magnetic material 10 surround the periphery can effectively enhance the magnetic flux around all the pillars 20a, provide an effective magnetic channel, and is beneficial to reducing magnetic loss, enhancing saturation capacity, improving efficiency and shrinking volume.

Still referring to FIG. 5d, the vertical separation groove 29 is formed to divide the 20b into two parts, i.e., 21b and 22b. Certainly, the manner in which the separation groove 29 is formed is also applicable to the method described in the above embodiments. Similarly, in the present embodiment, the magnetic material may also be added into the separation groove 29 as done in the above embodiment.

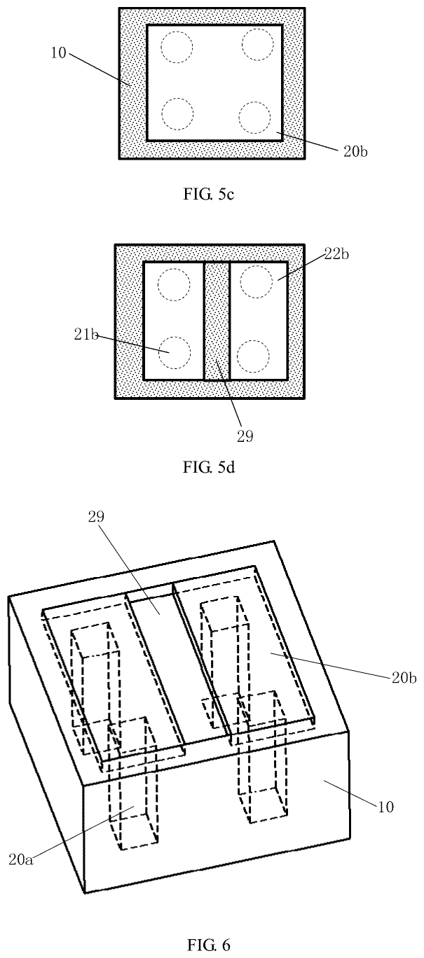

FIG. 6 is a perspective view illustrating the stereoscopic structure of the inductor shown in FIG. 5b to FIG. 5d. As can be seen from FIG. 6, it is an inductor with a non-crossed winding, that is, the four pillars 20a arranged in two rows and two pillars in the diagram do not electrically connect two diagonally symmetrical pillars 20a together as shown in FIG. 2. Rather, they electrically connect the adjacent two pillars 20a (it is shown in FIG. 6 that two pillars 20a on the left side are electrically connected, at the same time, two pillars 20a on the right side are also electrically connected).

### Embodiment 4

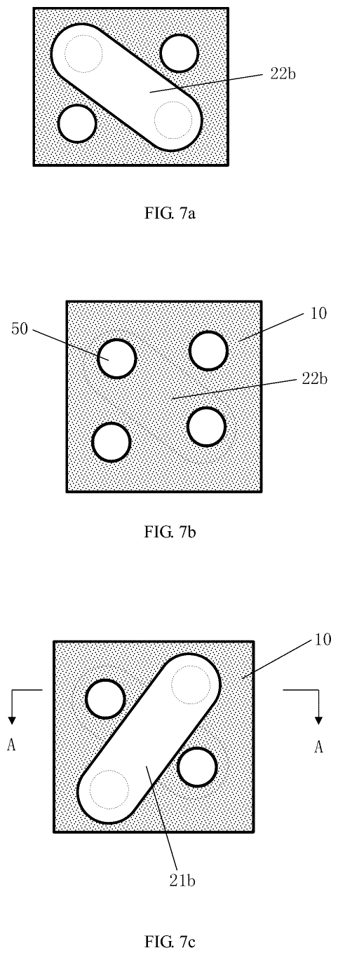

The difference between FIG. 7 and Embodiment 2 is that both windings for the crossing are located at the same end of a magnetic channel in Embodiment 2, but at two ends of the magnetic channel (at different side of the magnetic core) in the present embodiment, thus projections of the two windings for the crossing in the present embodiment cross each other on the end surface of the magnetic channel. As shown in FIG. 7a, the connection piece 21b is completely removed when the separation groove 29 is formed at one end surface of the magnetic channel as shown in FIG. 1d, leaving only the connection piece 22b.

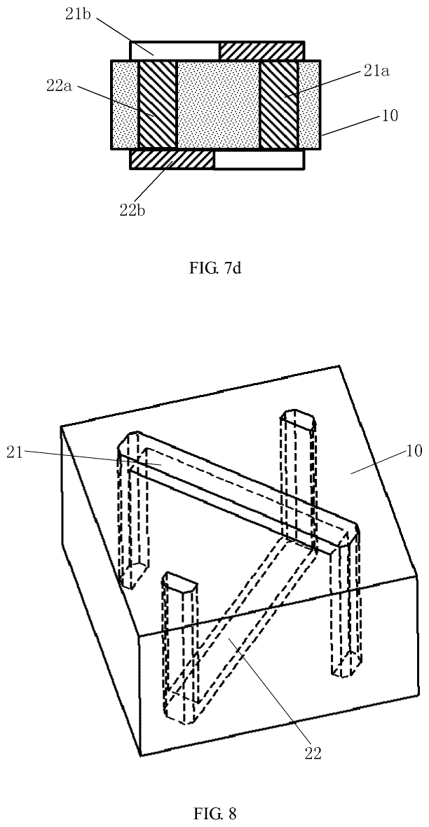

FIG. 7b is a view of the other end surface of the magnetic channel of the structure shown in FIG. 7a. As shown in FIG. 7b, the connection piece 22b (shown in dashed lines) and two pillars 20a electrically connected thereto form a first winding, and two ends of the first winding form two pads 50. Then, as shown in FIG. 7c, the connection piece 21b is provided on the basis of the end surface of the magnetic channel shown in FIG. 7b, electrically connecting the other two pillars 20a, so as to form a second winding. FIG. 7d is a cross-sectional view taken along A-A of FIG. 7c, and FIG. 8 is a perspective view illustrating the stereoscopic structure of the inductor shown in FIG. 7c. As shown in FIG. 8, the first winding and the second winding cross at two ends of the magnetic channel, that is, the projections of both the first winding and the second winding on the same plane cross with each other. Understandably, such a projection surface can be any end surface of the magnetic channels in FIG. 8 (i.e., the upper surface or the lower surface in FIG. 8).

### Embodiment 5

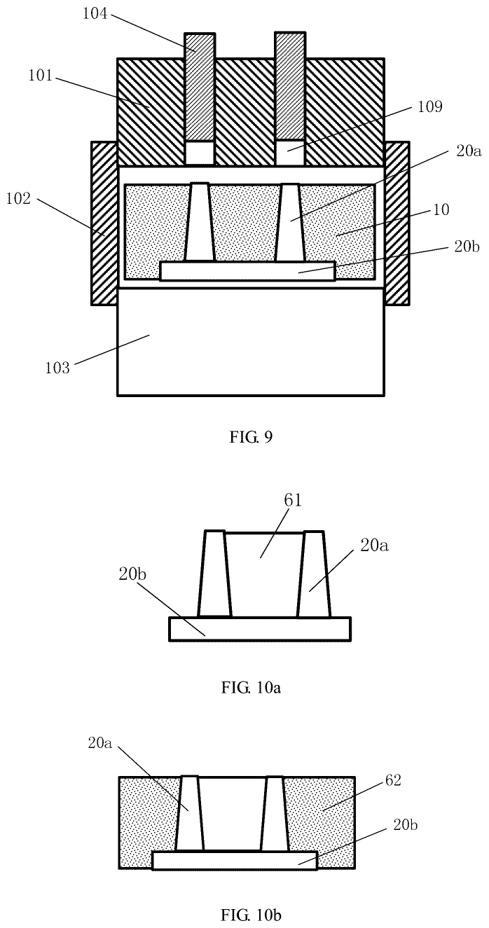

As shown in FIG. 9, the difference between the present embodiment and the above embodiments is that a through hole 109 is provided at a position on the upper punch of the injection molding tooling corresponding to the pillar 20a, so that the magnetic material 10 will not be pressed from the top downwards onto the pillar 20a when the magnetic material 10 is being injected, and that the upper surface of the pillar 20a can be exposed after the completion of the injection, so that it may be used as a pad for external connection.

By the method of the present embodiment, it is possible to prevent the pillar 20a from being covered by the magnetic material 10, eliminating the need for any post processing to expose the upper surface of the pillar 20a, thereby simplifying the process and reducing the cost. Moreover, the upper punch 101 does not apply any pressure to the magnetic material 10 on the upper surface of the pillar 20a, that is, this part of the magnetic material 10 is prevented from transmitting the impact force from the injection molding tooling to the pillar 20a, thereby avoiding collapse, deformation or bending and improving the performance of the finished product.

Optionally, in order to facilitate cleaning of inner side of the through hole 109 and avoid excessive accumulation of the magnetic material 10 in the through hole 109 after a period of use, a piston 104 may be disposed in the through hole 109 as shown in FIG. 9. In this way, the piston 104 may be stamped down once every injection, or several injections, to remove the residue magnetic material 10 or other debris in the through hole 109, so as to effectively improve the injection efficiency of the injection molding tooling, thus increasing product yield and durability.

### Embodiment 6

The difference between the present embodiment and the above embodiments is that the magnetic material 10 injected onto the conductive member 20 in the present embodiment includes at least two kinds of magnetic powders having different relative magnetic permeability.

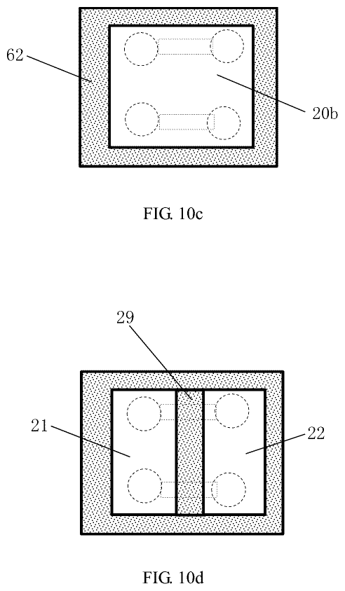

Still referring to FIG. 10a, second magnetic powder 61 is filled between at least two adjacent pillars 20a. The second magnetic powder 61 may also be pre-injected into a second magnetic core that is in turn pre-assembled with the conductive member 20 and then placed into a mold tooling, alternatively or simultaneously. Then, first magnetic powder 62 is filled into and injected over the outer side of the pillar 20a as shown in FIG. 10b, and the first magnetic powder 62 surrounds the second magnetic powder 61. FIG. 10c is a bottom view of FIG. 10b illustrating that the first magnetic powder 62 surround the conductive member 20. Afterwards, the separation groove 29 is formed by cutting as shown in FIG. 10d, thereby forming the first winding 21 and the second winding 22, which do not cross with each other. In the present embodiment, the second magnetic powders 61 having different magnetic permeability are disposed between the windings, offering benefits to adjustment of the coupling coefficient between the windings of the two phases, and expanding the applicability of the present process method to multi-phase coupled magnetic elements. In the present embodiment, the second magnetic powder 61 and the first magnetic powder 62 have different relative magnetic permeability. In some examples, the magnetic permeability of the second magnetic powder 61 is less than that of the first magnetic powder 62. For example, the relative magnetic permeability of the second magnetic powder 61 is approximately equal to 1, e.g., greater than or equal to 0.99 and less than or equal to 1.01, and may be, e.g., an epoxy resin material. Certainly, in other examples, the second magnetic powder 61 and the first magnetic powder 62 having the same relative magnetic permeability may also be used.

Certainly, in some examples, the second magnetic powder 61 may also be pressed to form a second magnetic core, and/or the first magnetic powder 62 may be pressed to form a first magnetic core, which may be pre-assembled with the conductive member 20 before being heated and pressurized to form an integrated whole. For example, the second magnetic powder 61 and the first magnetic powder 62 may be respectively pre-pressed to form a second magnetic core and a first magnetic core, be assembled with the conductive member 20, and then placed in an injection molding mold to be heated and pressurized to integrate the second magnetic core and the first core with the conductive member 20.

It will be readily appreciated that in some examples, only the magnetic material, rather than magnetic materials having different relative magnetic permeabilities may be wrapped around the conductive member 20. In other examples, it is also possible to use only a plurality of magnetic materials having different relative magnetic permeabilities, rather than a magnetic material, to wrap the conductive member 20 around the conductive member 20.

### Embodiment 7

The difference between the present embodiment and the above embodiments is that the plurality of pillars 20a disposed on the connection piece 20b are integrated first, and the first magnetic powder 62 is injected first, and then the integrated magnetic pillar 61 is divided and be filled with the second magnetic powder 61. The second magnetic powder 61 may have a different relative magnetic permeability from the first magnetic powder 62, to form a magnetic element of a composite material.

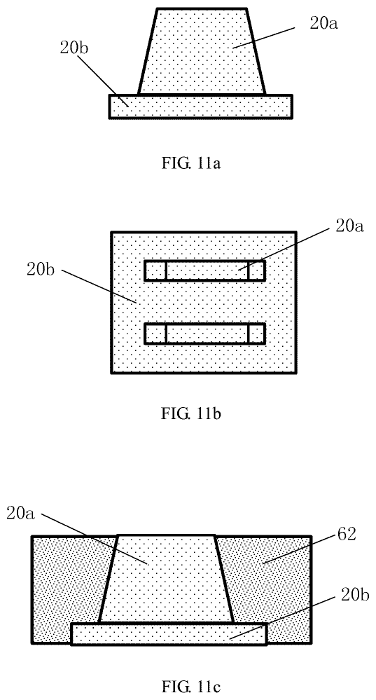

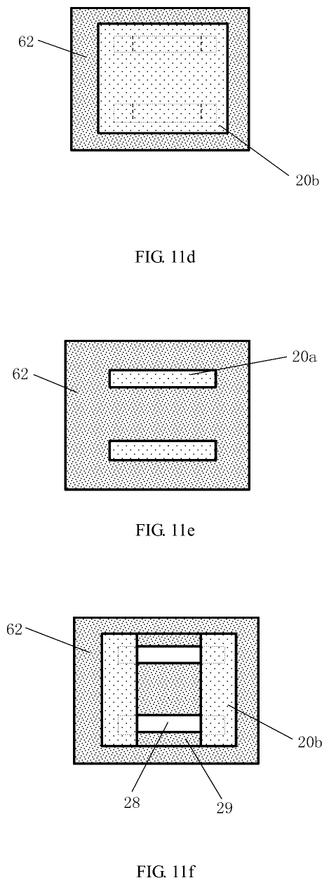

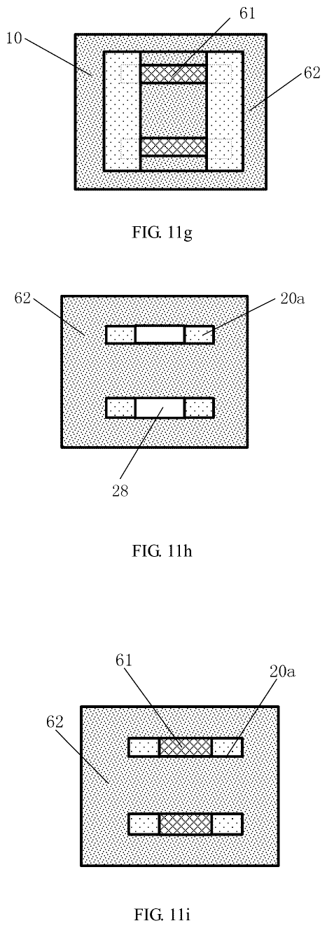

As shown in FIG. 11a, an elongated pillar 20a is provided on the connection piece 20b, and FIG. 11b is a top view of FIG. 11a. Then, as shown in FIG. 11c, the magnetic material 10 (i.e., the first magnetic powder 62) is injected onto the conductive member 20, or the pre-injection layer of the first magnetic powder 62 is pressed into a first magnetic core, and then assembled together with the conductive member 20. It should be understood that such assembling can be performed before or after the conductive member 20 is placed in the mold. FIG. 11d is a bottom view of FIG. 11c, and FIG. 1l is a top view of FIG. 11c. Then, as shown in FIG. 11f, a separation groove 29 is formed on the basis of FIG. 11d to expose the intermediate connection portion of the pillar 20a. Then, a separation groove 28 is formed on the intermediate connection portion. For example, the separation groove 28 can be formed by removing the intermediate connection portion by means of etching or laser cutting. Afterwards, as shown in FIG. 11g, on the basis of FIG. 11f, the second magnetic powder 61 having a different relative magnetic permeability is filled into the separation groove 28.

In other examples, as shown in FIG. 11h, a separation slot 28 may also be formed on the basis of FIG. 11e. Then, as shown in FIG. 11i, on the basis of FIG. 11h, second magnetic powder 61 having a different relative magnetic permeability is filled into the separation groove 28. Preferably, the relative magnetic permeability of the second magnetic powder 61 is less than that of the first magnetic powder 61. Preferably, the relative magnetic permeability of the second magnetic powder 61 is greater than or equal to 0.99 and less than or equal to 1.01, and may be, e.g., an epoxy resin material. Certainly, the second magnetic powder 61 may also be pre-pressed into a second magnetic core that is to be placed into the separation groove 28.

### Embodiment 8

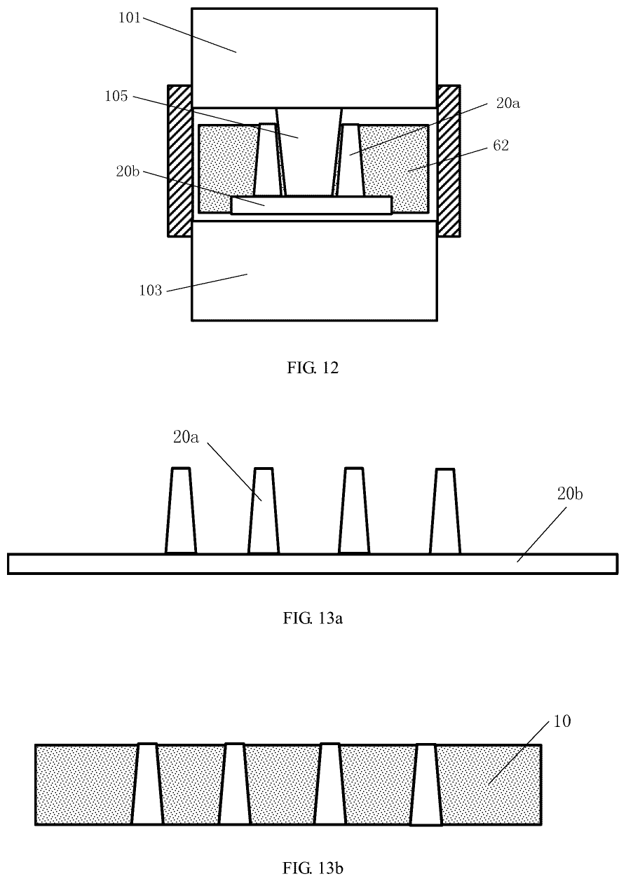

As shown in FIG. 12, the difference between the embodiment and the above embodiments is that the upper punch 101 of the injection molding tooling is provided with a bump 105. When the injection is performed, the conductive member 20 is placed in the mold, and the first magnetic powder 62 or the first magnetic core pressed and formed from the first magnetic powder 62 is added. Certainly, when the first magnetic core is added, it is also possible that the first magnetic core and the conductive member 20 are pre-assembled and then put into the mold. Since the upper punch 101 is provided with the bump 105, the space between the pillars 20a can be filled by the bump 105, and then the separation groove 28 can be naturally formed after the injection is completed, and then the second magnetic powder 61 is filled into the separation groove 28 as shown in FIG. 11g or FIG. 11i, as described in Embodiment 7. Preferably, the relative magnetic permeability of the second magnetic powder 61 is less than that of the first magnetic powder 62. Preferably, the relative magnetic permeability of the second magnetic powder 61 is greater than or equal to 0.99 and less than or equal to 1.01, and may be, e.g., an epoxy resin material. Certainly, the second magnetic powder 61 may be pre-pressed into the magnetic core that is placed into the separation groove 28.

It should be noted that in the Embodiments 6 to 8, the magnetic element is realized by using various kinds of magnetic powder, which can realize a magnetic element of a composite magnetic powder material of various structural forms. For example, the second magnetic powder may be arranged between at least two adjacent pillars 20a. Then the first magnetic powder surrounds the second magnetic powder. The phrase “first magnetic powder surrounds the second magnetic powder” may be implemented in that the first magnetic powder surrounds the second magnetic powder and the two adjacent pillars 20a, as shown in FIG. 10c and FIG. 11i. In addition, when a second magnetic powder is also disposed between the other two adjacent pillars in FIG. 10b and four segments of the second magnetic powder and the pillars are linked together to form a ring structure, then the first magnetic powder around all of the pillars will encloses all the pillars and the second magnetic powder. Generally, the phrase “first magnetic powder surrounds the second magnetic powder” is intended to mean that some of the intersection points between rays, which are drawn from the second magnetic powder towards any direction parallel to the connection piece 20b, and the first magnetic powder can always be selected to form a closed curve surrounding the second magnetic powder.

### Embodiment 9

The difference between the present embodiment and the above embodiments is that the magnetic material is firstly pre-pressed into a magnetic core matching the shape of the conductive member 20, and then the magnetic core and the conductive member 20 are assembled together, and then integrated as a whole by injection.

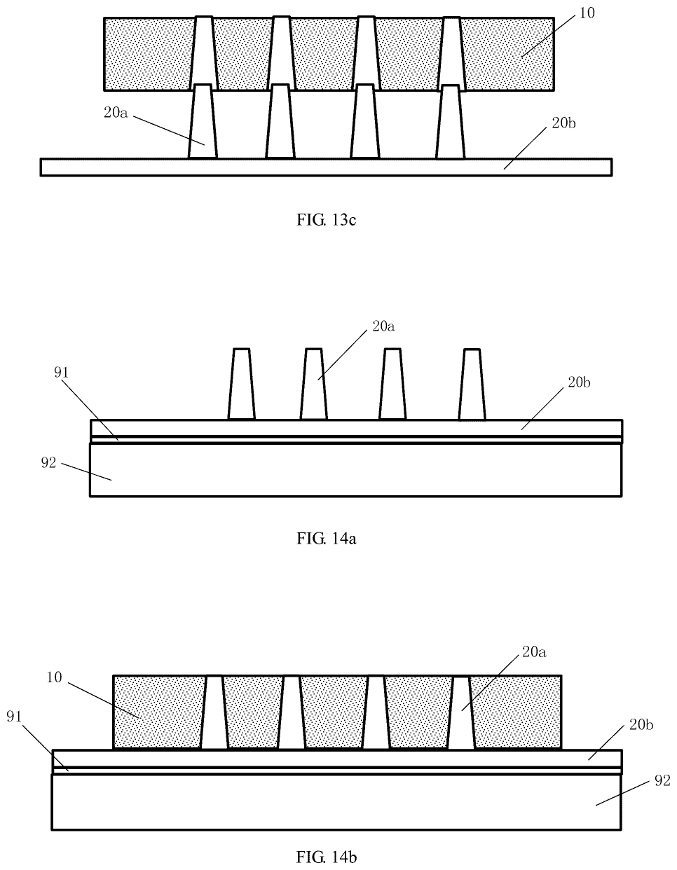

Specifically, as shown in FIG. 13a, there is provided a conductive member 20 including a connection piece 20b and a pillar 20a that is disposed on the connection piece and capable of conducting electricity. As shown in FIG. 13b, there is provided a magnetic core that is pre-pressed and at least has a hole structure matching the pillar 20a, that is, the shape of the magnetic core structure matches the surface shape of the side of the conductive member 20 having the pillars. Then, as shown in FIG. 13c, the magnetic core structure and the conductive member 20 are pre-assembled and then placed into a mold. The magnetic core structure and the conductive member 20 with the pillar 20a are integrated by injection using an injection molding die. During the injection process, at least one of the injection molding tooling and the magnetic core may be heated to a suitable temperature to facilitate the formation of the integrated structure. Certainly, the magnetic material 10 can also be pre-pressed into a plurality of magnetic cores that are then pre-assembled with the conductive member 20 before being placed into the mold to be integrated. In some examples, different materials may be used for the magnetic cores. For example, materials having different relative magnetic permeabilities may be used separately. Please refer to the above embodiments for the process after the completion of the injection, which will not be repeated again.

In the fabrication method of the present embodiment, the force applied to the pillar 20a during the injection process can be reduced, thereby reducing the deformation of the pillar 20a.

### Embodiment 10

As shown in FIG. 14a, the difference between the present embodiment and the above embodiments is that, when the connection piece 20b is large or relatively thin, a reinforcement part 92 is bonded by an adhesive 91 onto a surface of the connection piece 20b, facing away from the pillar 20a to reduce the deformation of the connection piece 20b, thereby improving the accuracy of the inductor.

Specifically, the connection piece 20b may be integrated with a part having higher strength and rigidity (i.e., the reinforcement part 92) by a temperature-sensitive adhesive, or a chemical sensitive adhesive, or a photosensitive adhesive or the like, thereby increasing the strength of the connection piece 20b through the reinforcement part 92.

Then, as shown in FIG. 14b, the magnetic material 10 is injected from the side of the conductive member 20 with the pillar onto the conductive member 20, so that the magnetic material 10 is integrated with the connection piece 20b and the pillar 20a.

Next, the adhesive 91 may be subjected to a degumming treatment by heating, chemical treatment, or light exposure according to actual needs, so that the connection piece 20b is detached from the reinforcement part 92. It will be readily appreciated that if the chemical treatment is employed for the degumming, it may be necessary to form the reinforcement part 92 into a porous structure having a plurality of vertical through holes to facilitate penetration of the chemicals. Similarly, if the reinforcement part 92 and the connection piece 20b are separated by a photosensitive method, it may be necessary to make the reinforcement part 92 to be transparent.

### Embodiment 11

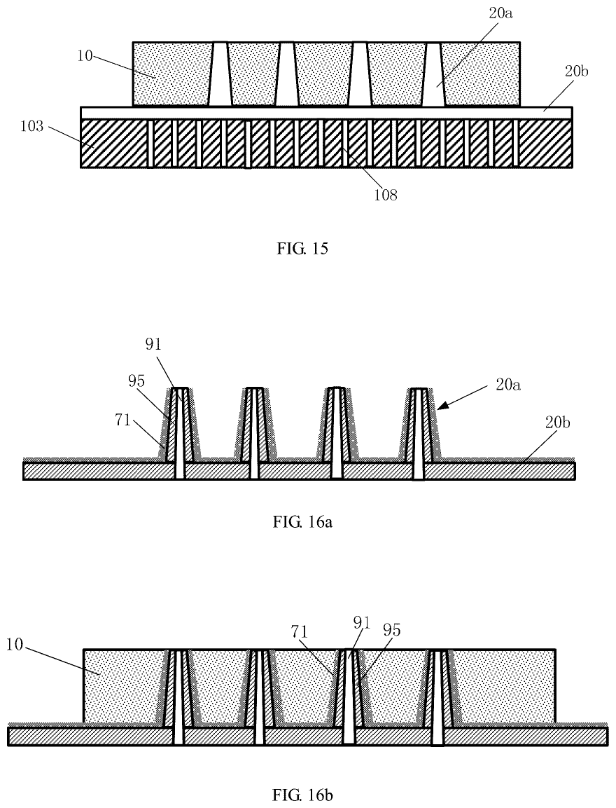

As shown in FIG. 15, the difference between the present embodiment and the above embodiments is that a plurality of vertical adsorption through holes 108 are disposed on the undershoot 103, and then the connection piece 20b can be adsorbed to the undershoot 103 by means of vacuum adsorption, to facilitate subsequent injection of the magnetic material 10 onto the conductive member 20.

### Embodiment 12

As shown in FIG. 16a, the difference between the present embodiment and the above embodiments is that the conductive member 20a is composed of multiple layers. For example, in some examples, the pillar 20a can include a reinforcement inner core 91 and a conductive layer 95 that is coated over the reinforcement inner core 91. For example, the reinforcement inner core 91 may be a high-strength material, such as steel, and the conductive layer 95 may be a material having high electrical conductivity, such as copper or silver coated over the reinforcement inner core 91. Based on this, the rigidity and strength of the pillar 20a can be enhanced, thereby reducing the deformation of the pillar 20a during the injection. It should be noted that the present embodiment is particularly suitable for manufacturing a magnetic element in a high frequency environment since the current in the magnetic element in a high frequency application scenario primarily concentrate in its surface.

Still referring to FIG. 16a, in some examples, a layer of other material 71 may be further applied over the outer surface of the pillar 20a and the connection piece 20b, and then the magnetic material 10 is injected onto the pillar side of the conductive member 20 coated with the other material 71, as shown in FIG. 16b. Specifically, the other material 71 may be a high voltage resistant insulation material to increase the withstand voltage rating between pillars 20a. Alternatively, the other material 71 may be an etching resistant material, so that the underlying magnetic material 10 will not be damaged when the connection piece 20b is being etched to form the separation groove 29.

### Embodiment 13

On the basis of the above embodiments, the present embodiment forms a new conductive trace between the pillars 20a by means of metallized wiring.

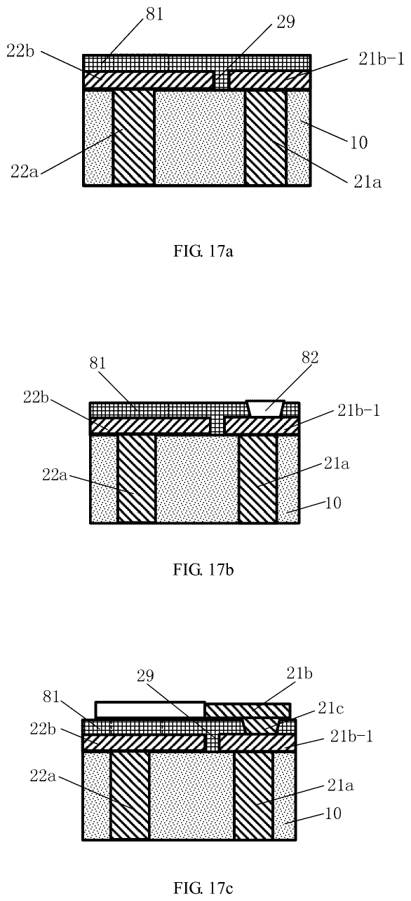

Specifically, as shown in FIG. 17a, which is equivalent to a cross-sectional view of FIG. 3a, an insulation material such as a PP material, an ABF material or the like is used to form an insulation layer 81 on the top of FIG. 3a (i.e., the surface of the conductive member 20 facing away from the pillar 20a). Then, as shown in FIG. 17b, a via 82 is formed on the top of the connection piece 21b-1. Finally, as shown in FIG. 17c, a metal conductive via 21c and a conductive layer 21b are generated by a metallization method.

### Embodiment 14

In the present embodiment, on the basis of Embodiment 13, a conductive line is also formed on the surface of the pillar side of the connection piece by means of metalizing a wiring layer.

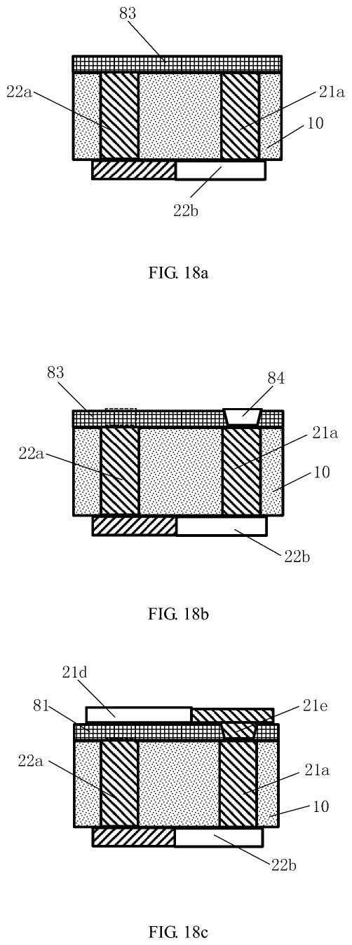

Specifically, as shown in FIG. 18a, the insulation layer 83 is formed using an insulation material such as a PP material, an ABF material or the like on the surface of the pillar side of the connection piece 20b (Certainly, the conductive member 20 has been injected with the magnetic material 10). Then, as shown in FIG. 18b, the through hole 84 is formed on the top of pillar 21a. Finally, as shown in FIG. 18c, a conductive via 21e and a conductive layer 21d are formed by means of a metallized method.

### Embodiment 15

The difference between the present embodiment and the above embodiments is that the conductive member 20 of the present embodiment is fabricated by injection.

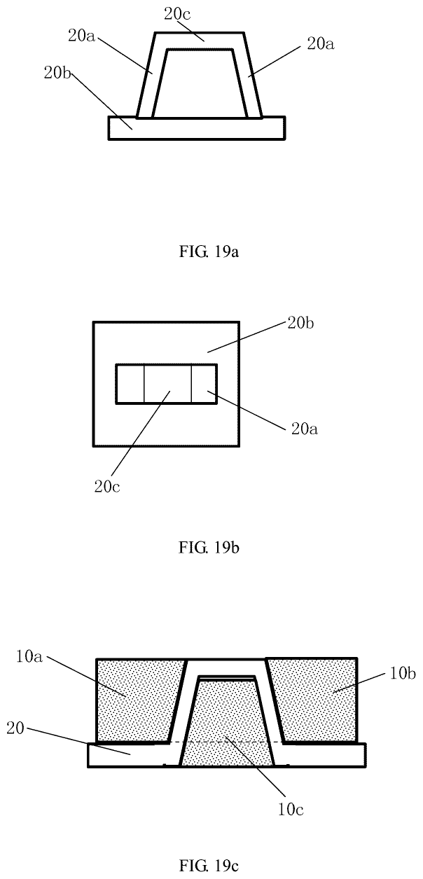

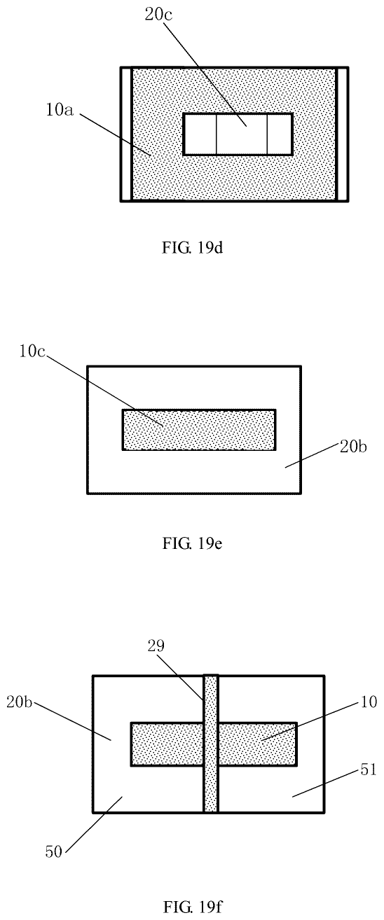

As shown in FIG. 19a, a sheet metal, such as a copper plate, is provided to undergo stamping to forma connection piece 20b and a plurality of pillars 20a perpendicular to the surface of the connection piece 20b, that is, the sheet metal is stamped to produce the conductive member 20. In FIG. 19a, two pillars 20a are formed by stamping, and the two pillars 20a are also short-connected with each other through the short connection piece 20c. Certainly, the two pillars 20a and the short connection piece 20c may be regarded together as one pillar.

FIG. 19b is a top view of FIG. 19a. As shown in FIG. 19b, the adjacent two pillars 20a are integrated together through the connected part, i.e., the short connection piece 20c.

As shown in FIG. 19c to FIG. 19e (where FIG. 19d is a top view of FIG. 19c and FIG. 19e is a bottom view of FIG. 19c), the magnetic cores 10a, 10b and 10c are injected onto the conductive member 20. For example, these magnetic cores 10a, 10b and 10c may be pre-assembled with the conductive member 20 and then placed in an injection molding tooling for injection, so that the magnetic cores 10a, 10b, 10c and the conductive member 20 are integrated together. Certainly, rather than injecting the magnetic cores 10a, 10b, and 10c onto the conductive member 20, it is also possible to place the conductive member 20 in an injection molding tooling and then fill in the magnetic powder to integrate the magnetic powder and the conductive member 20 together to make the finished product. It can be understood that heating can be applied during the molding process. The magnetic cores 10a and 10b may be pre-integrated or pre-assembled. The materials of the magnetic cores 10a, 10b, and 10c may be the same or different. For example, materials having different relative magnetic permeability may be used, respectively.

Finally, as shown in FIG. 19f, on the basis of FIG. 19e, a separation groove 29 is formed on the connection piece 20b. The two exposed conductive portions 50 and 51 shown in FIG. 19f can be used as lead pins.

### Embodiment 16

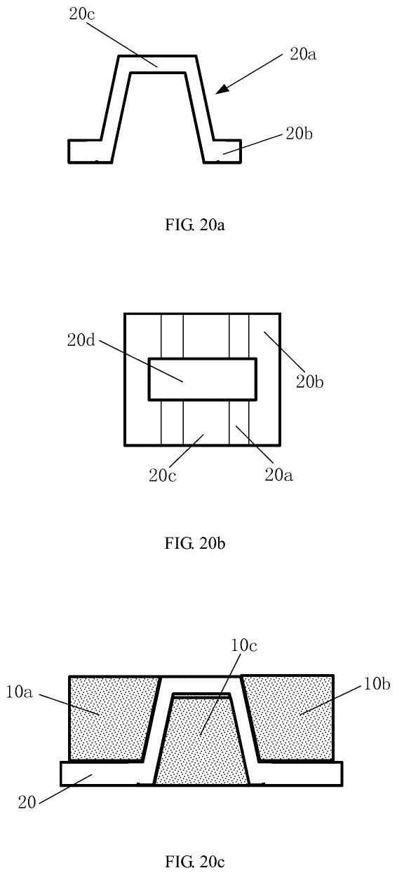

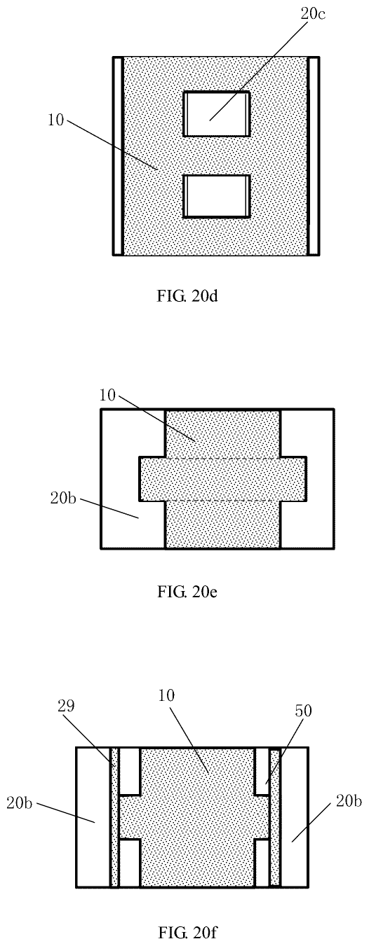

The difference between the present embodiment and embodiment 15 is that the conductive member 20 is formed by stamping and bending the entire connection piece 20b. Specifically, first, the sheet metal is stamped, so that the profile of the stamped sheet metal has a shape as shown in FIG. 20a. Then, a hole 20d is formed on the top surface of the stamped sheet metal to form four vertical pillars 20a. FIG. 20b is a top view, as can be seen from FIG. 20b, the adjacent two pillars 20a are connected to each other through the connected part, i.e., the short connection piece 20c.

Then, the magnetic material is injected onto the conductive member 20. For example, the magnetic cores 10a, 10b and 10c can be injected onto the conductive member 20 as shown in FIG. 20c. In some examples, the magnetic cores 10a and 10b may be integrated together, that is, the magnetic cores 10a and 10b are integrally pre-formed into a magnetic core structural member. The materials of the magnetic cores 10a, 10b, and 10c may be the same or different. For example, materials having different relative magnetic permeabilities may be used, respectively. The magnetic cores 10a, 10b, and 10c are assembled with the conductive member 20 and then placed in an injection molding tooling to receive injection, so that the magnetic cores 10a, 10b, 10c and the conductive member 20 are integrated together. FIG. 20d is a top view of FIG. 20c, and FIG. 20e is a bottom view of FIG. 20c.

It should be understood that, in some examples, the magnetic core 10c may not be used. Instead, it may be possible to fill in the magnetic powder after the magnetic cores 10a and 10b have been assembled with the conductive member 20 and then placed in the injection molding tooling. In other words, the magnetic cores 10a and 10b may be pre-pressed from the first magnetic powder 62 (or the second magnetic powder 61) described above. Then, the magnetic cores 10a and 10b are assembled with the conductive member 20 and placed in the injection molding tooling. Next, as shown in FIG. 20c, the position corresponding to the magnetic core 10c in the mold is filled with the second magnetic powder 61 (or the first magnetic powder 62). Then, the magnetic cores 10a and 10b, the conductive member 20 and the second magnetic powder 61 (or the first magnetic powder 62) are injected. Alternatively, instead of using the magnetic cores 10a and 10b, it may be possible to fill in the magnetic powder after the magnetic core 10c has been assembled with the conductive member 20 and placed in the injection molding tooling. In other words, the magnetic core 10c may be pre-pressed from the first magnetic powder 62 (or the second magnetic powder 61). Then, the magnetic core 10c is assembled with the conductive member 20 and placed in the injection mold. Next, as shown in FIG. 20c, the position corresponding to the second magnetic powder 61 (or the first magnetic powder 62) is filled with the second magnetic powder 61 (or the first magnetic powder 62). Then, the magnetic core 10c, the conductive member 20 and the second magnetic powder 61 (or the first magnetic powder 62) are injected. Similarly, heating may be applied during the injection in the present embodiment.

Finally, as shown in FIG. 20f, on the basis of FIG. 20e, a separation groove 29 is formed on the connection piece 20b, and the four pads 50 exposed at the bottom in FIG. 20f can serve as lead pins. Certainly, in some examples, the portion corresponding to 20b in FIG. 20f can also be removed.

### Embodiment 17

The difference between the present embodiment and Embodiment 15 or Embodiment 16 is that the pillars, which are stamped from sheet metal, on the conductive member 20 are not short-circuited to each other through the short connection piece 20c.

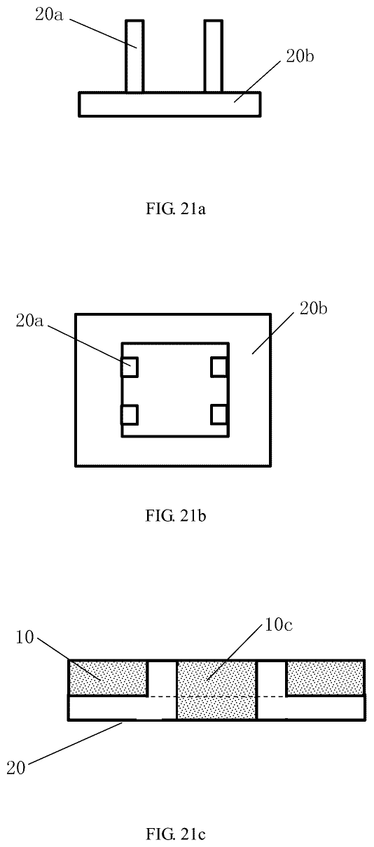

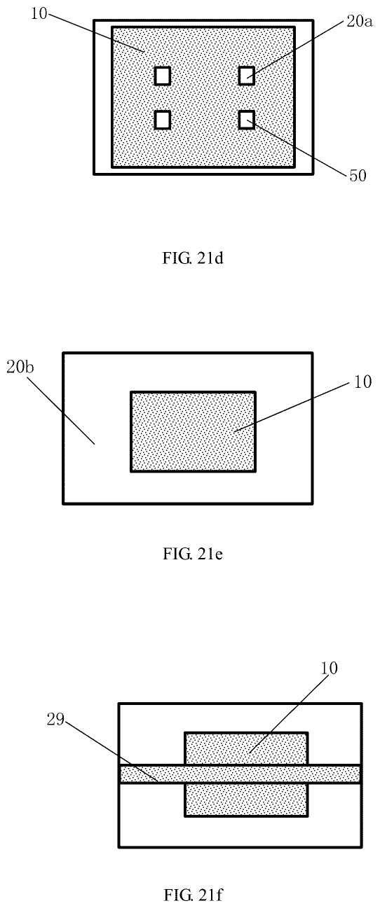

Specifically, the sheet metal is firstly stamped, so that the sheet metal having been stamped has a profile shaped as shown in FIG. 21a, and a top surface shaped as shown in FIG. 21b. As can be seen from the top view shown in FIG. 21b, the sheet metal has an opening in the middle after being stamped, and the four pillars 20a are disposed around the opening. The opening in the middle may provide the pillar 20a with a sheet metal material. Certainly, instead of the middle opening, an opening may also be formed on the periphery of the connection piece 20a to provide the pillar 20a with the sheet metal material. Since there is no short-connection piece 20c for connecting the pillars 20a, an advantage has been achieved in allowing the magnetic material to flow in a direction from the pillar 20a toward the connection piece 20b during the injection process.

As shown in FIG. 21c, which is a side view, the conductive member 20 is placed in a mold, and then the magnetic powder is filled into the mold and injected with the conductive member 20, forming an integrated structure. Certainly, in some examples, the magnetic powder may be pre-pressed into a magnetic core structural member, and then the magnetic core structural member and the conductive member 20 are assembled and placed in an injection molding mold for injection, so that the magnetic core and the conductive member 20 are integrated together, and heating may also be applied during the injection process. FIG. 21d is a top view of FIG. 21c, and FIG. 21e is a bottom view of FIG. 21c.

As shown in FIG. 21f, a separation groove 29 is formed on the connection piece 20b on the basis of FIG. 21e to form two windings. The exposed end surfaces of the four pillars 20a in FIG. 21d may form a terminal 50 for external connection.

In each of the above embodiments, the magnetic material may be a magnetic core pre-pressed into a shape matching that of the conductive member. The phrase “the magnetic core and the conductive member are put into a mold” means that the magnetic core and the conductive member are put into the mold after they are assembled, or they are separately or simultaneously put into the mold. Preferably, the magnetic core and the conductive member conduct match each other when combined together in the mold. The magnetic core and the conductive member are hot pressed, so that the magnetic core and the conductive member are integrated together. Before the hot pressing, other magnetic material, such as other magnetic powder material, may also be added. In addition, the magnetic material in the embodiments may include a variety of magnetic materials, e.g., two kinds of magnetic materials including first magnetic powder and second magnetic powder. The relative magnetic permeabilities of the first magnetic powder may be different from that of the second magnetic powder. The magnetic material is injected onto the conductive member, so that the magnetic material and the conductive member form an integrated structure. Specifically, the first magnetic powder may be pressed to form a first magnetic core with a shape matching that of the conductive member. The first magnetic core and the conductive member are placed in a mold. The second magnetic powder is filled in the mold. The first magnetic core, the second magnetic powder and the conductive member are hot pressed, so that the first magnetic core and the second magnetic powder and the conductive member form an integrated structure. Alternatively, the second magnetic powder may be injected to form a second magnetic core with a shape matching that of the conductive member. The second magnetic core and the conductive member are placed in the mold. The first magnetic powder is filled into the mold. The second magnetic core, the first magnetic powder and the conductive member are hot pressed, so that the second magnetic core, the first magnetic powder and the conductive member may form an integrated structure. Alternatively, the first magnetic powder may be pressed to form a first magnetic core, and the second magnetic powder may form a second magnetic core. The shapes of the first magnetic core and the second magnetic core match that of the conductive member. The first magnetic core, the second magnetic core and the conductive member are placed in the mold. The first magnetic core, the second magnetic core and the conductive member are hot pressed, so that the first magnetic core, the second magnetic core and the conductive member may form an integrated structure. The magnetic core may be injected onto the conductive member from the pillar side, or the magnetic core may be disposed on the side opposite to the pillar side on the conductive member, and then the magnetic powder material is injected onto the pillar side.

In view of the above, in order to form an inductor with a vertical winding, it is generally necessary to firstly provide a conductive member 20 including a connection piece and a pillar, where the pillar is vertically disposed on one of the surfaces of the connection piece. Then, the magnetic material is injected onto the conductive member 20 from the pillar side (the magnetic material may be a magnetic core structural member which is pre-pressed, or may be magnetic powder filled into an injection molding tooling), so that the magnetic material and the conductive member may form an integrated structure. Finally, the connection piece is cut to form a preset winding, so as to form a magnetic element. In some cases, the conductive member 20 can be fabricated by etching, soldering, electroplating, engraving, or stamping and such. In addition, for a multi-phase coupled magnetic element, the cross or uncross vertical winding can be obtained depending on the manner and the position of cutting the connection piece.

It should be understood that the terms “upper”, “lower”, “front”, “back”, “left”, “right”, “vertical”, “horizontal”, “top”, “bottom”, “inside”, “outside” and such indicate the orientation and position relationship based on the orientation or positional relationship shown in the appended drawings, and are merely for the convenience of describing the disclosure and for the simplification of description, rather than indicating or implying that the device or element referred to must have any particular orientation and be constructed and operated when in any particular orientation. Therefore, they cannot be understood as limitations on the disclosure.

Moreover, the terms “first” and “second” are used for descriptive purposes only and are not to be construed as indicating or implying a relative importance or implicitly indicating the number of technical features indicated. Thus, features defined with “first” or “second” may include at least one of the features, either explicitly or implicitly. In the description of the present disclosure, the term “a plurality of” means at least two, e.g., two, three, etc., unless specifically defined otherwise.

Finally, it should be noted that the above embodiments are only used to illustrate the technical solutions of the present disclosure, and are not to be taken in a limiting sense. Although the present disclosure has been described in detail with reference to the embodiments described above, those of ordinary skill in the art should understand that the technical solutions described in the above embodiments may be modified, or some or all of the technical features may be replaced by their equivalents; and the modifications or substitutions do not cause the essence of the corresponding technical solutions to deviate from the scope of the technical solutions of the embodiments of the present disclosure.

What is claimed is:

1. An injection molding tooling of an inductor with a vertical winding, comprising: an upper punch, a molding cavity body and a lower punch, the lower punch being configured to bear a connection piece of a conductive member, the molding cavity body being disposed around a periphery of a pillar of the conductive member, and the upper punch being configured to stamp a magnetic material, such that the magnetic material and the conductive member form an integrated structure.

2. The injection molding tooling according to claim 1, wherein the molding cavity body, the conductive member and the lower punch enclose an injection molding cavity; and the upper punch is configured to stamp the magnetic material after the magnetic material has been filled into the injection molding cavity.

3. The injection molding tooling according to claim 1, wherein a through hole directly facing the pillar is formed on the upper punch, and a piston movable along the through hole is provided within the through hole.

4. The injection molding tooling according to claim 1, wherein a bump is formed on the bottom of the upper punch, a shape of the bump matching a shape of a cavity defined by two adjacent ones of the pillars; and
an adsorption through hole for vacuum adsorption is formed in the lower punch.

5. The injection molding tooling according to claim 1, wherein the connection piece comprises a first surface and a second surface that are oppositely arranged, and the pillar is disposed on the first surface; and
the connection piece is cut into multiple parts, wherein at least one part of the multiple parts and a corresponding pillar thereof form the vertical winding;
wherein the cut connection piece comprises a separation groove formed by removing a portion of the connection piece by cutting a channel with a depth in the connection piece, and other portions of the cut connection piece horizontally corresponding in depth to the separation groove;
wherein an upper surface of the pillar is exposed from the magnetic material at a surface of the integrated structure.

6. The injection molding tooling according to claim 1, wherein the magnetic material is a magnetic core pre-pressed and the magnetic core having a shape matching the shape of the conductive member.

7. The injection molding tooling according to claim 1, wherein the magnetic material comprises first magnetic powder and second magnetic powder, wherein the second magnetic powder has a relative magnetic permeability less than that of the first magnetic powder or the second magnetic powder has a relative magnetic permeability greater than or equal to 0.99 and less than or equal to 1.01.

8. The injection molding tooling according to claim 7, wherein the first magnetic powder forms a first magnetic core having a shape matching a shape of the conductive member; and
the first magnetic powder, the second magnetic powder and the conductive member form an integrated structure.

9. The fabrication method according to claim 7, wherein the second magnetic powder to forms a second magnetic core having a shape matching a shape of the conductive member; and
the second magnetic powder, the first magnetic powder and the conductive member form an integrated structure.

10. The fabrication method according to claim 7, wherein the first magnetic powder forms a first magnetic core, the second magnetic powder forms a second magnetic core, a shape of the first magnetic core and a shape of the second magnetic both matching a shape of the conductive member; and
the magnetic material and the conductive member form an integrated structure.
